(19) United States
(12) Patent Application Publication
(10) Pub. No.: US 2017/0124528 A1
(43) Pub. Date: May 4, 2017

(54) SYSTEM AND METHOD FOR HEALTH CONSCIOUS EVENT MANAGEMENT

(71) Applicant: International Business Machines Corporation, Armonk, NY (US)

(72) Inventors: Al Chakra, Apex, NC (US); Jonathan Dunne, Dungarvan (IE); Liam Harpur, Dublin (IE); Asima Silva, Holden, MA (US)

(21) Appl. No.: 15/399,818

(22) Filed: Jan. 6, 2017

Related U.S. Application Data
(63) Continuation of application No. 14/926,356, filed on Oct. 29, 2015.

(51) Int. Cl. G06Q 10/10; G06F 19/00

(52) U.S. Cl. CPC G06Q 10/1095; G06F 19/3418; G06F 19/322

(57) ABSTRACT

A method, computer program product, and computer system for receiving, by a computing device, health data of a user recorded via a health monitoring device. The health data may be compared to one or more calendar events attended by the user. An effect of the one or more calendar events on the health data may be determined. One or more aspects of the one or more calendar events affecting the health data may be identified.

### BACKGROUND

Some people may be working longer and harder than before. As such, management of one's day (including non-work days) may be accomplished by the use of, e.g., a calendar, where events (such as work meetings) may be noted in an available time slot. From time to time, people may have days where the day's agenda may be more hectic than others, such as with a series of back to back meetings, or other meeting patterns. These types of days may affect one's health.

### BRIEF SUMMARY OF DISCLOSURE

In one example implementation, a method, performed by one or more computing devices, may include but is not limited to receiving, by a computing device, health data of a user recorded via a health monitoring device. The health data may be compared to one or more calendar events attended by the user. An effect of the one or more calendar events on the health data may be determined. One or more aspects of the one or more calendar events affecting the health data may be identified.

One or more of the following example features may be included. The health data may include a heart rate of the user. The health data may include a blood pressure of the user. At least one of the one or more aspects affecting the health data may include at least one attendee of the one or more calendar events. At least one of the one or more aspects affecting the health data may include at least one topic of the one or more calendar events. An action may be performed on at least one future calendar event based upon, at least in part, the one or more aspects of the one or more calendar events affecting the health data. The action may include at least one of rescheduling and delegating the at least one future calendar event.

In another example implementation, a computing system includes a processor and a memory configured to perform operations that may include but are not limited to receiving health data of a user recorded via a health monitoring device. The health data may be compared to one or more calendar events attended by the user. An effect of the one or more calendar events on the health data may be determined. One or more aspects of the one or more calendar events affecting the health data may be identified.

One or more of the following example features may be included. The health data may include a heart rate of the user. The health data may include a blood pressure of the user. At least one of the one or more aspects affecting the health data may include at least one attendee of the one or more calendar events. At least one of the one or more aspects affecting the health data may include at least one topic of the one or more calendar events. An action may be performed on at least one future calendar event based upon, at least in part, the one or more aspects of the one or more calendar events affecting the health data. The action may include at least one of rescheduling and delegating the at least one future calendar event.

In another example implementation, a computer program product resides on a computer readable storage medium that has a plurality of instructions stored on it. When executed by a processor, the instructions cause the processor to perform operations that may include but are not limited to receiving health data of a user recorded via a health monitoring device. The health data may be compared to one or more calendar events attended by the user. An effect of the one or more calendar events on the health data may be determined. One or more aspects of the one or more calendar events affecting the health data may be identified.

One or more of the following example features may be included. The health data may include a heart rate of the user. The health data may include a blood pressure of the user. At least one of the one or more aspects affecting the health data may include at least one attendee of the one or more calendar events. At least one of the one or more aspects affecting the health data may include at least one topic of the one or more calendar events. An action may be performed on at least one future calendar event based upon, at least in part, the one or more aspects of the one or more calendar events affecting the health data. The action may include at least one of rescheduling and delegating the at least one future calendar event.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a health process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the health process of FIG. 1 according to one or more example implementations of the disclosure;

FIG. 4 is an example risk model/quotient according to one or more example implementations of the disclosure;

FIG. 5 is an example diagrammatic view of a screen image displayed by the health process of FIG. 1 according to one or more example implementations of the disclosure; and

FIG. 6 is an example diagrammatic view of a screen image displayed by the health process of FIG. 1 according to one or more example implementations of the disclosure.

Like reference symbols in the various drawings indicate like elements.

### DETAILED DESCRIPTION

### System Overview:

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

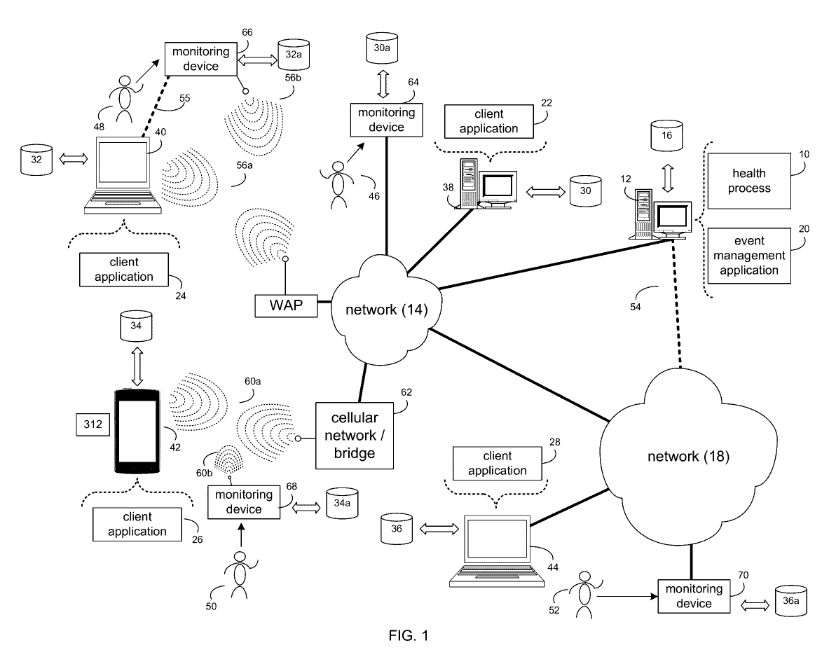

Referring now to FIG. 1, there is shown health process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, health process 10 may receive, by a computing device, health data of a user recorded via a health monitoring device. The health data may be compared to one or more calendar events attended by the user. An effect of the one or more calendar events on the health data may be determined. One or more aspects of the one or more calendar events affecting the health data may be identified.

The instruction sets and subroutines of health process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. The data store may also be a custom database, such as, for example, a flat file database or an XML database. Any other form(s) of a data storage structure and/or organization may also be used. Health process 10 may be a component of the data store, a standalone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute an event management application (e.g., event management application 20), examples of which may include, but are not limited to, e.g., a web conferencing application, a video conferencing application, a voice-over-IP application, a video-over-IP application, an email application (e.g., an email server application), a calendar application, an Instant Messaging (IM)/“chat” application, a short messaging service (SMS)/multimedia messaging service (MMS) application, or other application that allows for event management, virtual meeting and/or remote collaboration. Health process 10 and/or event management application 20 may be accessed via client applications 22, 24, 26, 28. Health process 10 may be a standalone application, or may be an applet/application/script/extension that may interact with and/or be executed within event management application 20, a component of event management application 20, and/or one or more of client applications 22, 24, 26, 28. Event management application 20 may be a standalone application, or may be an applet/application/script/extension that may interact with and/or be executed within health process 10, a component of health process 10, and/or one or more of client applications 22, 24, 26, 28. One or more of client applications 22, 24, 26, 28 may be a standalone application, or may be an applet/application/script/extension that may interact with and/or be executed within and/or be a component of health process 10 and/or event management application 20. Examples of client applications 22, 24, 26, 28 may include, but are not limited to, e.g., a web conferencing application, a video conferencing application, a voice-over-IP application, a video-over-IP application, an email application (e.g., an email server application), a calendar application, an Instant Messaging (IM)/“chat” application, a short messaging service (SMS)/multimedia messaging service (MMS) application, or other application that allows for event management, virtual meeting and/or remote collaboration, a monitoring device application, a standard and/or mobile web browser, an email application (e.g., an email client application), a textual and/or a graphical user interface, a customized web browser, a plugin, an Application Programming Interface (API), or a custom application. Examples of a monitoring device application may include but is not limited to, e.g., a health monitor application, or any other device application capable of monitoring and/or recording health statistics (e.g., heart rate, blood pressure, temperature, etc.) of a user. Examples of a monitoring device may include but is not limited to, e.g., a wrist band, a watch, a health monitor, or any other device capable of monitoring and/or recording health statistics (e.g., heart rate, blood pressure, temperature, etc.) of a user. The instruction sets and subroutines of client applications 22, 24, 26, 28, which may be stored on storage devices 30, 32, 34, 36, 30a, 32a, 34a, 36a, coupled to client electronic devices 38, 40, 42, 44 and/or monitoring devices 64, 66, 68, 70, may be executed by one or more processors (not shown) and one or more memory architectures (not shown) incorporated into client electronic devices 38, 40, 42, 44 and/or monitoring devices 64, 66, 68, 70.

Storage devices 30, 32, 34, 36, 30a, 32a, 34a, 36a, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Additionally/alternatively, client electronic devices 38, 40, 42, 44 may include a monitoring device (e.g., monitoring devices 64, 66, 68, 70). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of health process 10 (and vice versa). Accordingly, health process 10 may be a purely server-side application, a purely client-side application, or a hybrid server-side/client-side application that is cooperatively executed by one or more of client applications 22, 24, 26, 28 and/or health process 10.

One or more of client applications 22, 24, 26, 28 (and/or monitoring device applications) may be configured to effectuate some or all of the functionality of event management application 20 (and vice versa). Accordingly, event management application 20 may be a purely server-side application, a purely client-side application, or a hybrid server-side/client-side application that is cooperatively executed by one or more of client applications 22, 24, 26, 28 and/or event management application 20. As one or more of client applications 22, 24, 26, 28 (and/or monitoring device applications), health process 10, and event management application 20, taken singly or in any combination, may effectuate some or all of the same functionality, any description of effectuating such functionality via one or more of client applications 22, 24, 26, 28, health process 10, event management application 20, or combination thereof, and any described interaction(s) between one or more of client applications 22, 24, 26, 28 (and/or monitoring device applications), health process 10, event management application 20, or combination thereof to effectuate such functionality, should be taken as an example only and not to limit the scope of the disclosure.

Users 46, 48, 50, 52 and/or monitoring devices 64, 66, 68, 70 may access computer 12 and health process 10 (e.g., using one or more of client electronic devices 38, 40, 42, 44) directly through network 14 or through secondary network 18. Further, computer 12 may be connected to network 14 through secondary network 18, as illustrated with phantom link line 54. Health process 10 may include one or more user interfaces, such as browsers and textual or graphical user interfaces, through which users 46, 48, 50, 52 may access health process 10 and/or monitoring devices 64, 66, 68, 70.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14. The various client electronic devices and/or monitoring devices 64, 66, 68, 70 may be directly or indirectly coupled to network 14 (or network 18). For example, personal computer 38 and monitoring device 64 are shown directly coupled to network 14 via a hardwired network connection. Further, notebook computer 44 and monitoring device 70 are shown directly coupled to network 18 via a hardwired network connection. Laptop computer 40 and monitoring device 66 are shown wirelessly coupled to network 14 via wireless communication channels 56a and 56b respectively established between laptop computer 40 and wireless access point (i.e., WAP) 58 and between monitoring device 66 and WAP 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56a between laptop computer 40 and WAP 58 and wireless communication channel 56b between monitoring device 66 and WAP 58. Additionally/alternatively, a monitoring device (e.g., monitoring device 66) may be directly (and/or wirelessly) coupled to a client electronic device (e.g., client electronic device 40) as illustrated with phantom link line 55. Thus, information may be communicated from a monitoring device (e.g., monitoring device 66) to a client electronic device (e.g., client electronic device 40), where the information may be communicated, e.g., to computer 12 via, e.g., a network (e.g., network 14). Smart phone 42 and monitoring device 68 are shown wirelessly coupled to network 14 via wireless communication channels 60a and 60b respectively established between smart phone 42 and cellular network/bridge 62 and monitoring device 68 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices (e.g., monitoring devices 64, 66, 68, 70) to be interconnected using a short-range wireless connection. Other forms of interconnection (e.g., Near Field Communication (NFC)) may also be used.

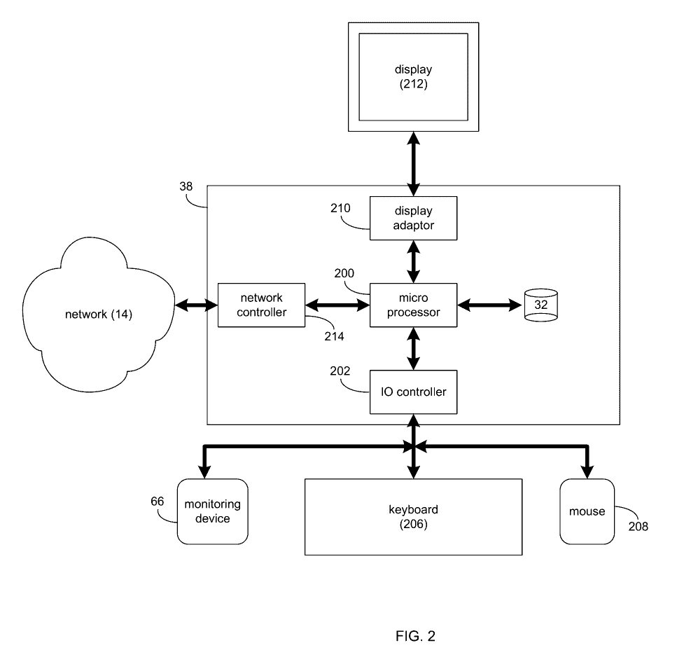

Referring also to FIG. 2, there is shown a diagrammatic view of client electronic device 40. While client electronic device 40 is shown in this figure, this is for illustrative purposes only and is not intended to be a limitation of this disclosure, as other configurations are possible. For example, any computing device capable of executing, in whole or in part, health process 10 may be substituted for client electronic device 40 within FIG. 2, examples of which may include but are not limited to computer 12 and/or client electronic devices 38, 42, 44 and/or monitoring devices 64, 66, 68, 70.

Client electronic device 40 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 32). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., monitoring device 66), USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

### The Health Process:

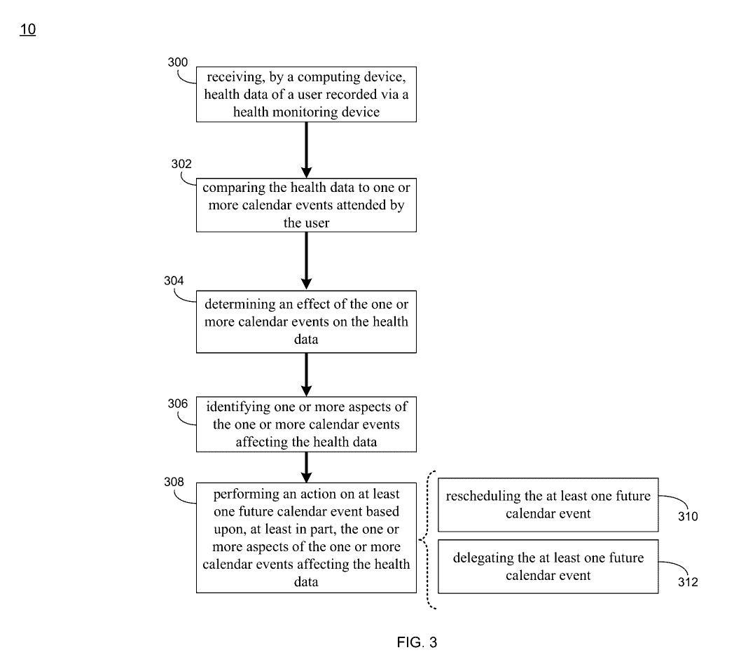

As discussed above and referring also at least to FIGS. 3-6, health process 10 may receive 300, by a computing device, health data of a user recorded via a health monitoring device. Health process 10 may compare 302 the health data to one or more calendar events attended by the user. Health process 10 may determine 304 an effect of the one or more calendar events on the health data. Health process 10 may identify 306 one or more aspects of the one or more calendar events affecting the health data.

As noted above, some people may be working longer and harder than before. As such, management of one's day (including non-work days) may be accomplished by the use of, e.g., a calendar, where events (such as work meetings) may be noted in an available time slot. From time to time, people may have days where the day's agenda may be more hectic than others, such as with a series of back to back meetings, or other meeting patterns. For example, as will be discussed in greater detail below, with an abundance of meetings, one thing that may be apparent is the effect either back to back meetings and/or specific meetings with specific attendees/topics may have on one's health. As will also be discussed in greater detail below, health process 10 may be used to understand the how a user's information (e.g., calendar/meetings/schedule patterns) may affect one's health. In some implementations, if a pattern is identified, health process 10 may enable remedial action to be taken.

In some implementations, health process 10 may receive 300 health data of a user recorded via a health monitoring device. For instance, assume for example purposes only that a user (e.g., user 48) is/has been wearing a monitoring device (e.g., monitoring device 66). In the example, monitoring device 66 may be, e.g., a wrist band capable of monitoring certain health data. In some implementations, the health data may include a heart rate of user 48. In some implementations, the health data may include a blood pressure of user 48. Monitoring devices capable of monitoring health data (e.g., blood pressure, heart rate, temperature, etc.) are known in the art. In some implementations, health process 10 may receive the health data directly from monitoring device 66. In some implementations, the health data may be received 300 and stored in the above-noted data store. It will be appreciated that the health data may be received 300 from the above-noted data store, which may store historic health data associated with user 48. While the present disclosure includes the ability to monitor blood pressure, heart rate, and temperature, using known health monitoring wrist bands, it will be appreciated that any monitoring device capable of monitoring any health (statistics) data may be used without departing from the scope of the present disclosure.

In some implementations, health process 10 may compare 302 the health data to one or more calendar events attended by the user. For instance, and continuing with the above example, assume that the details associated with an event (e.g., a business meeting) may be available in the entry in the calendar application. For instance, assume for example purposes only that the above-noted business meeting is listed in an entry in calendar application (e.g., event management application 20). In the example, health process 10 may access the details (e.g., attendees of the business meeting, topic of the business meeting, free time before the business meeting, free time after the business meeting until another event, etc.) associated with the business meeting in the entry in the calendar application to compare 302 the health data to the business meeting in the entry in the calendar application. For instance, assume for example purposes only that the business meeting was on Jul. 25, 2014. In the example, health process 10 (e.g., via monitoring device 66 worn by user 48 during the business meeting) may receive 300 the health data (e.g., heart rate, blood pressure, etc.) recorded during the business meeting and may compare 302 that health data with the calendar entry associated with the business meeting. Thus, in the example, health process 10 may triangulate the captured health data to the calendar of user 48. While the present disclosure describes leverage health monitoring via monitoring device 66 during a particular calendar event, it will be appreciated that health process 10 may leverage real-time health monitoring via monitoring device 66 during a typical working day, an atypical work day, non-work day, or any other day/particular calendar event without departing from the scope of the present disclosure.

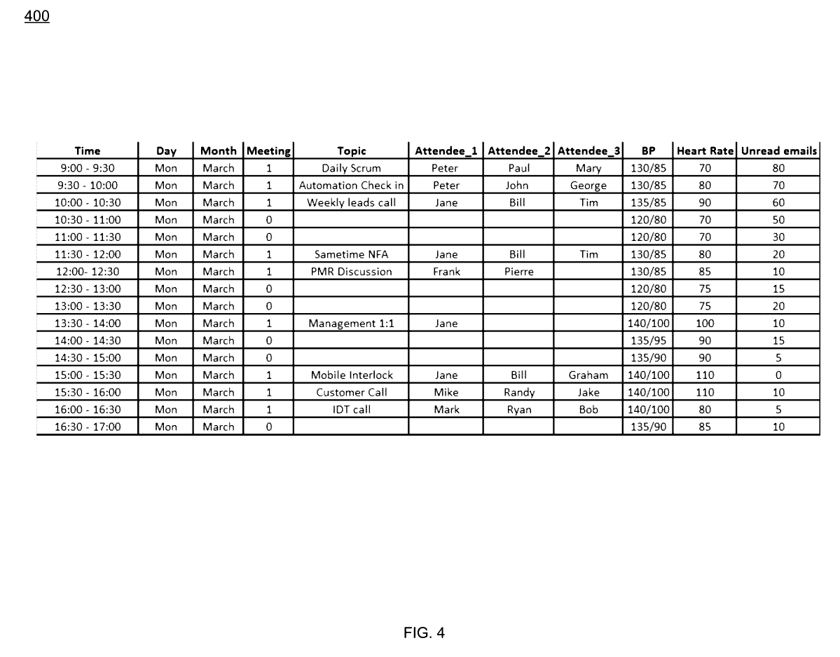

Health process 10 may determine 304 an effect of the one or more calendar events on the health data. For instance, and continuing with the above example, further assume that user 48 attends an event (e.g., the business meeting), there may be a number of factors that may have a bearing on the health of user 48. For example, if user 48 is in a meeting, any number of the following example situations may occur: user 48 may be thinking about all the work (e.g., unread e-mails) needed to be done before leaving for the day, the topic being discussed may be very stressful, an individual in the meeting may act in a confrontational way, etc. In the example, as noted above, assume for example purposes only that the above-noted business meeting is listed in an entry in calendar application (e.g., event management application 20). In the example, further assume that the details associated with the business meeting (e.g., attendees of the business meeting, topic of the business meeting, etc.) may be available in the entry in the calendar application. In the example, health process 10 may access the details associated with the business meeting in the entry in the calendar application to compare 302 the health data to the business meeting in the entry in the calendar application, and determine 304 an effect of the business meeting on the health data of user 48. For instance, and referring at least to FIG. 4, an example risk model/quotient (e.g., chart 400) showing one or more details of the day (and individual calendar events) associated with user 48 is shown, along with one or more health statistic data associated with each calendar event. In the example, chart 400 details the example time intervals of the day (e.g., half hour intervals), day of the week, month, whether an event is a meeting (e.g., 1) or not a meeting (e.g., 0), the event topic, attendees of the event, the blood pressure/heart rate of user 48 during the associated event, number of unread emails at a particular time during the associated event, etc.

In the example, referring at least to time slot 13:30-14:00, it may be seen that the meeting topic is “Management 1:1”, attended by Jane. During the meeting, the blood pressure of user 48 rose to 140/100 (from 120/80) and the heart rate of user 48 rose to 100 (from 75). Thus, in the example, health process 10 may determine the effect of the business meeting on the health data of user 48 is to raise the blood pressure and the heart rate.

In some implementations, health process 10 may identify 306 one or more aspects of the one or more calendar events affecting the health data. In some implementations, at least one of the one or more aspects affecting the health data may include at least one attendee of the one or more calendar events, and at least one of the one or more aspects affecting the health data may include at least one topic of the one or more calendar events. For instance, and continuing with the above example, health process 10 may infer which meetings and which aspects of the meetings (e.g., attendees and topics) may contribute to elevated or lowered health metrics (e.g. blood pressure, heart rate, etc.). For example, health process 10 may analyze one or more aspects of the time slot 13:30-14:00 in table 400 to identify a likelihood that it may be the meeting topic of “Management 1:1”, the attendance of the meeting by Jane, the 10 unread emails, or combination thereof, that has affected the blood pressure and heart rate of user 48. However, it will be appreciated that in some implementations, the more historical health and calendar data capable of being compared 302 and analyzed by health process 10, the more accurate the prediction of risk. Thus, in the example, health process 10 may analyze both prior health and prior calendar data to determine which aspect(s) may contribute towards elevated health metrics. In the example, the above-noted risk model/quotient in chart 400 may be identified.

In some implementations, “risk” may be determined by health process 10 using, e.g., a generalized linear model (GLM), using, e.g., a multifactor regression analysis. For instance,

Risk=123.56+0.45Time+0.1Day+560Meeting+100Attendee_1+569Topic+12Unread Email, where “Time” may be the time of the meeting, “Day” may be the day of the meeting, “Meeting” may be the type of event, “Attendee” may be who is/was attending the event, “Topic” may be the topic of the event, and “Unread Email” may be the number of unread emails at the time of the event.

As noted above, the data may be accessible by health process 10 (e.g., via event management application 20). In the example, as will be discussed in greater detail below, the “risk” (e.g., the likelihood of elevation in blood pressure/heart rate) may be determined based upon thresholds. For instance, if risk is below “A”, then the 13:30-14:00 meeting may be labeled as low risk. As another example, if risk is above “A” but less than “B”, then the 13:30-14:00 meeting may be labeled as medium risk. As yet another example, if risk is above “B”, then the 13:30-14:00 meeting may be labeled as high risk. It will be appreciated that any other models (and/or thresholds) may be used to determine risk without departing from the scope of the present disclosure. As such, the use of the above-noted model to determine risk should be taken as an example only and not to otherwise limit the scope of the present disclosure.

In some implementations, health process 10 may enable user 48 to disregard captured health data. For instance, assume for example purposes only that user 48 enjoys walking on a treadmill during meetings. In the example, it may be the treadmill walking that raises the heart rate of user 48, rather than (or in combination with) the above-noted aspects of the meeting. Thus, this data may be an inaccurate representation of health data to be used in the above-noted GLM. As such, in the example, an user interface associated with health process 10 may be presented to user 48 with the option to disregard some or all of the health data obtained at a given point in time.

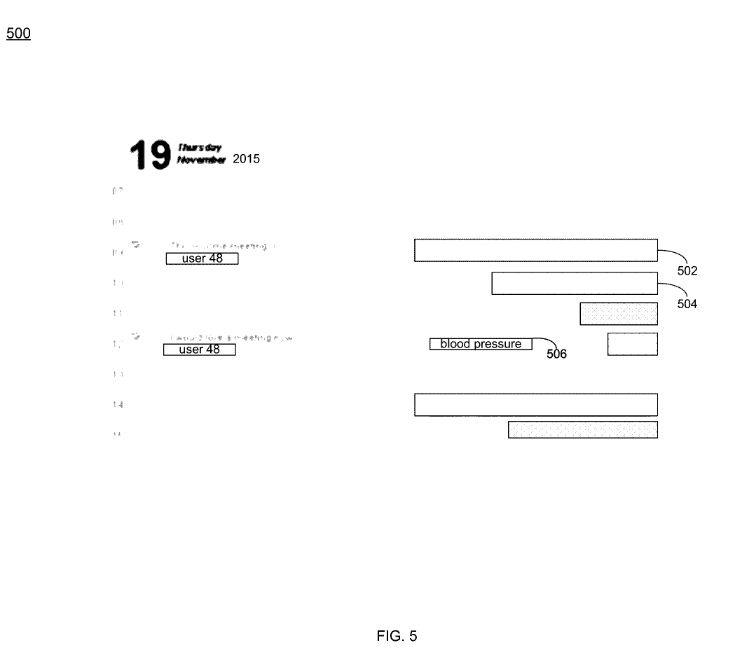

In some implementations, health process 10 may overlay the risk to health for future meetings. For instance, and referring at least to FIG. 5, an example overlay (e.g., overlay 500) of risk to health to one or more future calendar entries is shown. Assuming the above analysis has enabled health process 10 to better predict risk to identify the risk factors (e.g., aspects) identified 306, those aspects may be used to predict the effect on health metrics for similar aspects in future calendar entries, which may be labelled, e.g., as different designs (e.g., vertical stripes=low risk; crisscross=medium risk; downward diagonal=high risk), color coded (e.g., green=low risk; yellow=medium risk; red=high risk). In some implementations, the amount of risk may be indicated by the length of the objects overlaid onto the calendar entries. For instance, a longer vertical striped (low risk) object 502 may indicate a greater risk than a smaller vertical striped (low risk) object 504. In some implementations, the risk factor value may be labeled on the associated calendar entry. In some implementations, the health data that is predicted to be increased/decreased due to the above-noted analysis may be labeled on the associated calendar entry (e.g., blood pressure 506). It will be appreciated that any other design to overlay risk to health to one or more calendar entries may be used without departing from the scope of the present disclosure.

In some implementations, health process 10 may perform 308 an action on at least one future calendar event based upon, at least in part, the one or more aspects of the one or more calendar events affecting the health data. For instance, in some implementations, the action may include at least one of rescheduling 310 and delegating 312 the at least one future calendar event. For example, health process 10 may reschedule 310 and/or delegate 312 meetings if risk exceeds pre-defined thresholds (e.g., risk thresholds and/or health statistic thresholds). For instance, and referring again to the example overlay 500, assume that health process 10 has determined (using the above-noted analysis) that the future 12:00-13:00 meeting has a high risk factor indicating a high likelihood that one or more aspects of the meeting may have an effect on the health metrics (e.g., blood pressure) of user 48. In the example, health process 10 may, based at least upon the risk factor, alert user 48 (e.g., via pop-up window, email, text, etc.) to reschedule 310 (e.g., via health process 10) the meeting to another time slot, and/or may alert user 48 (e.g., via pop-up window, email, text, etc.) to delegate 312 (e.g., via health process 10) the meeting to be attended by another user.

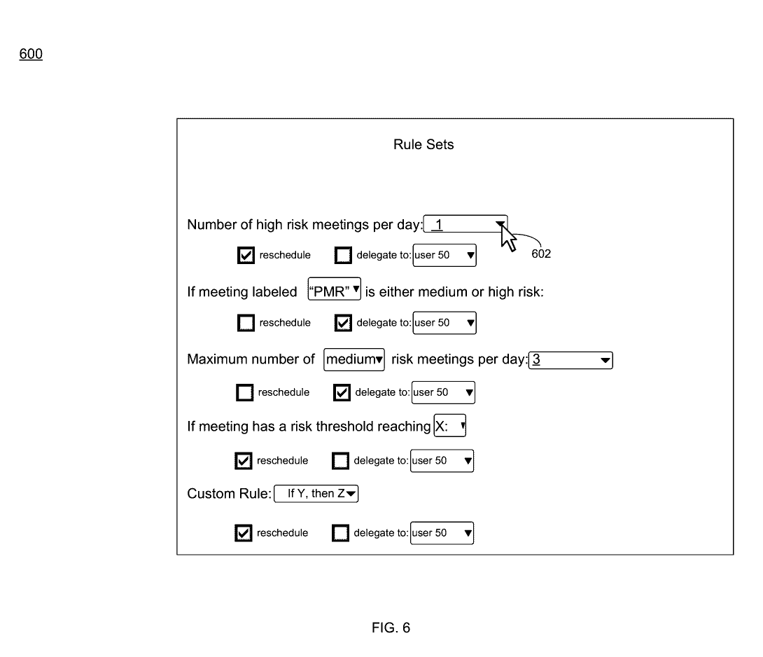

In some implementations, health process 10 may automatically reschedule 310 and/or delegate 312 meetings if risk exceeds pre-defined thresholds (e.g., risk thresholds and/or health statistic thresholds). For instance, and referring at least to FIG. 6, an example user interface (e.g., user interface 600) associated with health process 10 is shown. Based on, at least in part, risk identified by health process 10, health process 10 may enable user 48 to set a risk threshold parameters to auto delegate/auto reschedule to mitigate risk on in give day. In the example, user 48 (e.g., via health process 10) may customize rule sets for when to automatically reschedule 310 and/or delegate 312 meetings (and/or provide alerts for user 48 to manually reschedule 310 and/or delegate 312). In the example, the rule sets may include, e.g., a number of high risk meetings per day, whom to delegate a meeting if a particular topic of a meeting is to be discussed (with particular risk settings, a number of medium risk meetings per day, a risk threshold, etc. For instance, using a point device (e.g., cursor 602) health process 10 may enable user 48 to set the following rule set:
a) Ensure only one high risk meeting per day; if more than one, reschedule
b) If meeting is labeled “PMR” and/or is either medium or high risk, delegate to user 50
c) Ensure only 3 medium risk meetings on a given day; if more than 3, delegate to user 50
d) If risk threshold reaches X, then delegate to user 50 and/or reschedule
e) Custom rule

Thus, in the example, should the future 12:00-13:00 meeting violate any combination of the above-noted rule set, health process 10 may automatically reschedule 310 the meeting for another time/date, and/or may automatically delegate 312 the meeting to user 50. Similarly, in the example, should the future 12:00-13:00 meeting violate any combination of the above-noted rule set, health process 10 may automatically alert user 48 to manually reschedule 310 the meeting for another time/date, and/or may manually delegate 312 the meeting to user 50. In some implementations, health process 10 may periodically (e.g., every 5 minutes) check the calendar entries for new/revised entries, which may cause health process 10 to update the above-noted analysis and adjust one or more of the calendar entries according to the above-noted rule set. It will be appreciated that any other rule sets may be configured by user 48 (e.g., via health process 10 by default and/or manually) without departing from the scope of the present disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1. A computer-implemented method comprising:
receiving, by a computing device, health data of a user recorded via a health monitoring device;
comparing the health data to one or more calendar events attended by the user;
determining an effect of the one or more calendar events on the health data; and
identifying one or more aspects of the one or more calendar events affecting the health data.

2. The computer-implemented method of claim 1 wherein the health data includes a heart rate of the user.

3. The computer-implemented method of claim 1 wherein the health data includes a blood pressure of the user.

4. The computer-implemented method of claim 1 wherein at least one of the one or more aspects affecting the health data includes at least one attendee of the one or more calendar events.

5. The computer-implemented method of claim 1 wherein at least one of the one or more aspects affecting the health data includes at least one topic of the one or more calendar events.

6. The computer-implemented method of claim 1 further comprising performing an action on at least one future calendar event based upon, at least in part, the one or more aspects of the one or more calendar events affecting the health data.

7. The computer-implemented method of claim 6 wherein the action includes at least one of rescheduling and delegating the at least one future calendar event.

8.-20. (canceled)
